(19) United States
(12) Patent Application Publication
(10) Pub. No.: US 2018/0052359 A1
(43) Pub. Date: Feb. 22, 2018

(54) COLOR FILTER SUBSTRATE, SENSOR SUBSTRATE AND DISPLAY DEVICE

(71) Applicant: SHARP KABUSHIKI KAISHA, Sakai City, Osaka (JP)

(72) Inventors: TSUNEAKI UMEMOTO, Sakai City (JP); NORIKAZU HOHSHI, Sakai City (JP); TATSUYA KATOH, Sakai City (JP)

(21) Appl. No.: 15/558,569

(22) PCT Filed: Mar. 14, 2016
(86) PCT No.: PCT/JP2016/057983

§ 371 Date: Sep. 15, 2017

(30) Foreign Application Priority Data
Mar. 17, 2015 (JP) 2015-053499

(51) Int. Cl. G02F 1/1335; G06F 3/042; G02F 1/1333; G09F 9/30; G02B 5/20

(52) U.S. Cl. CPC G02F 1/133514; G06F 3/042; G02F 1/133512; G02F 2001/13312; G02F 1/1333; G09F 9/30; G02B 5/20; G02F 1/133528

(57) ABSTRACT

A color filter substrate includes: a transparent substrate; a black matrix formed at one surface side of the transparent substrate in a grid shape; color filters installed on regions of the transparent substrate divided by the black matrix; and optical sensors formed on one surface or the other surface of the transparent substrate to overlap the black matrix seen from a direction perpendicular to the transparent substrate.

### TECHNICAL FIELD

The present invention relates to a color filter substrate, a sensor substrate and a display device.

Priority is claimed on Japanese Patent Application No. 2015-053499, filed Mar. 17, 2015, the content of which is incorporated herein by reference.

### BACKGROUND ART

In recent years, in smart phones, tablet type computers, and other mobile devices, a contact detecting device that is referred to as a so-called touch panel is essentially required by a display device installed on a display surface such as a liquid crystal display device or the like. In such a display device, a display and various buttons can be shared by displaying the various buttons and detecting operations with respect to the displayed buttons through the touch panel. Accordingly, with the display device, for example, reduction in space, reduction in the number of parts, and so on can be achieved.

In the following Patent Document 1, an example in the related art of a display device including the above-mentioned touch panel is disclosed. Specifically, the following Patent Document 1 discloses a display device in which a common electrode for display of a liquid crystal display diode is shared as one of a pair of electrodes for a touch sensor, the other electrode (a detecting electrode for a sensor is newly formed, and a conventional common driving signal serving as a driving signal for display is shared as a driving signal for a touch sensor.

In the display device, a capacitance is formed between the common electrode and the detecting electrode for a sensor and a touch is detected using a variation of the capacitance due to contact with a finger. For this reason, the display device can also be adapted to mobile device applications where a potential of a user is often indeterminate. In addition, since a newly installed electrode may be only a detecting electrode for a sensor and it is unnecessary to newly prepare a driving signal for a touch sensor, the configuration is simple.

### PRIOR ART DOCUMENT

### Patent Document

### [Patent Document 1]

Japanese Unexamined Patent Application, First Publication No. 2009-244958

### SUMMARY OF THE INVENTION

### Problem to be Solved by the Invention

Incidentally, the display device disclosed in the above-mentioned Patent Document 1 detects a touch using a variation of a capacitance formed between the common electrode and the detecting electrode for a sensor due to contact with a finger, and basically uses an operation by a user with a finger as a target. For this reason, in the display device disclosed in the above-mentioned Patent Document 1, for example, it is difficult to detect minute operations using a stylus pen or the like.

In addition, the display device disclosed in the above-mentioned Patent Document 1 is provided to detect a variation in capacitance between the common electrode and the detecting electrode for a sensor generated due to contact with a finger. For this reason, in the display device disclosed in the above-mentioned Patent Document 1, while touch detection (detection of whether an operation by a finger was performed) is possible, a fingerprint of the finger performing the operation cannot be detected. For this reason, in the related art, when a fingerprint sensor needs to be installed, the fingerprint sensor should be installed separately from the touch sensor.

In consideration of the above-mentioned circumstances, some aspects of the present invention are to provide a color filter substrate, a sensor substrate and a display device that are capable of detecting minute operations using a pen or the like and a plurality of kinds of sensors can be realized by a single sensor.

### Means for Solving the Problems

To achieve the above-described problem, a color filter substrate (7), according to the one aspect of the present invention, includes: a transparent substrate (11); a light shielding pattern (31) formed at one surface side of the transparent substrate in a grid shape; color filters (12) installed on regions of the transparent substrate divided by the light shielding pattern; and optical sensors (35) formed on one surface or the other surface of the transparent substrate to overlap the light shielding pattern seen from a direction perpendicular to the transparent substrate.

In addition, in the color filter substrate according to one aspect of the present invention, the optical sensors may be disposed inside a retreat region (W1, W2) set at an end portion of the light shielding pattern.

In addition, in the color filter substrate according to one aspect of the present invention, the optical sensors may be formed between the transparent substrate and the light shielding pattern at one surface side of the transparent substrate.

In addition, in the color filter substrate according to one aspect of the present invention, the light shielding pattern may be formed to extend in a first direction x-axis direction) and a second direction (y-axis direction) that are perpendicular to each other at one surface side of the transparent substrate, and the optical sensors may be formed to overlap a first linear section (31a) extending in the first direction of the light shielding pattern, a second linear section (31b) extending in the second direction of the light shielding pattern, or an intersection at which the first linear section and the second linear section cross each other.

In addition, in the color filter substrate according to one aspect of the present invention, the optical sensors may have dot shapes when seen in a direction (z-axis direction) perpendicular to the transparent substrate or linear shapes extending in the first direction or the second direction.

In addition, in the color filter substrate according to one aspect of the present invention, the color filter may have a first color pattern (36R), a second color pattern (36G) and a third color pattern (36B), which are arranged in the first direction and the second direction, and the optical sensors may be installed to correspond to the first color pattern, the second color pattern and the third color pattern.

Alternatively, in the color filter substrate according to one aspect of the present invention, the color filter may have first color patterns (36R), second color patterns (36G) and third color patterns (36B), which are arranged in the first direction and the second direction, and the optical sensors may be installed in unit divisions (U1, U2, U3) each including a first color pattern, a second color pattern, and a third color pattern.

A sensor substrate (4(i) according to one aspect of the present invention includes: a substrate (41); and optical sensors (35) formed on one surface of the substrate to overlap a grid-shaped light shielding pattern (31) from a direction perpendicular to the substrate when the substrate overlaps a color filter substrate (7) on which the light shielding pattern is formed.

In addition, in the sensor substrate according to one aspect of the present invention, the optical sensors may be formed to be disposed inside a retreat region (W1, W2) set at an end portion of the light shielding pattern when the substrate overlaps the color filter substrate.

In addition, in the sensor substrate according to one aspect of the present invention, the substrate may be a polarizing plate or a glass substrate.

A display device (1) according to one aspect of the present invention includes: the color filter substrate (7) according to any one of the above-described color filter substrates.

Alternatively, a display device according to one aspect of the present invention includes: a color filter substrate (7) including a transparent substrate (11), a light shielding pattern (31) formed at one surface side of the transparent substrate in a grid shape, and color filters (12) installed on regions of the transparent substrate divided by the light shielding pattern; and the sensor substrate (7) according to any one of the above described sensor substrates.

### Effect of the Invention

According to some aspects of the present invention, since the optical sensor is formed to overlap the light shielding pattern when the transparent substrate on which the color filter and the light shielding pattern are formed is seen from a vertical direction, minute operations using a pen or the like can be detected. In addition, a plurality of kinds of sensors can be realized by a single sensor.

### BRIEF DESCRIPTION OF THE DRAWINGS

FIG. 1 is an exploded perspective view showing a schematic configuration of a display device according to a first embodiment of the present invention.

FIG. 2 is a cross-sectional view of the display device according to the first embodiment of the present invention.

FIG. 3 is a plan view of the display device according to the first embodiment of the present invention.

FIG. 4 is a cross-sectional view of a display device according to a second embodiment of the present invention.

FIG. 5 is a cross-sectional view of a display device according to a third embodiment of the present invention.

FIG. 6A is a first plan view showing a first variant of the display device according to the first to third embodiments of the present invention.

FIG. 6B is a second plan view showing the first variant of the display device according to the first to third embodiments of the present invention.

FIG. 7A is a first plan view showing a second variant of the display device according to the first to third embodiments of the present invention.

FIG. 7B is a second plan view showing the second variant of the display device according to the first to third embodiments of the present invention.

FIG. 8A is a first plan view showing a third variant of the display device according to the first to third embodiments of the present invention.

FIG. 8B is a second plan view showing the third variant of the display device according to the first to third embodiments of the present invention.

FIG. 8C is a third plan view showing the third variant of the display device according to the first to third embodiments of the present invention.

### EMBODIMENTS FOR CARRYING OUT THE INVENTION

Hereinafter, a color filter substrate, a sensor substrate and a display device according to embodiments of the present invention will be described in detail with reference to the accompanying drawings. Further, in the drawings referred to below, in order to make components easier to see, scales of dimensions may differ depending on the components.

### First Embodiment

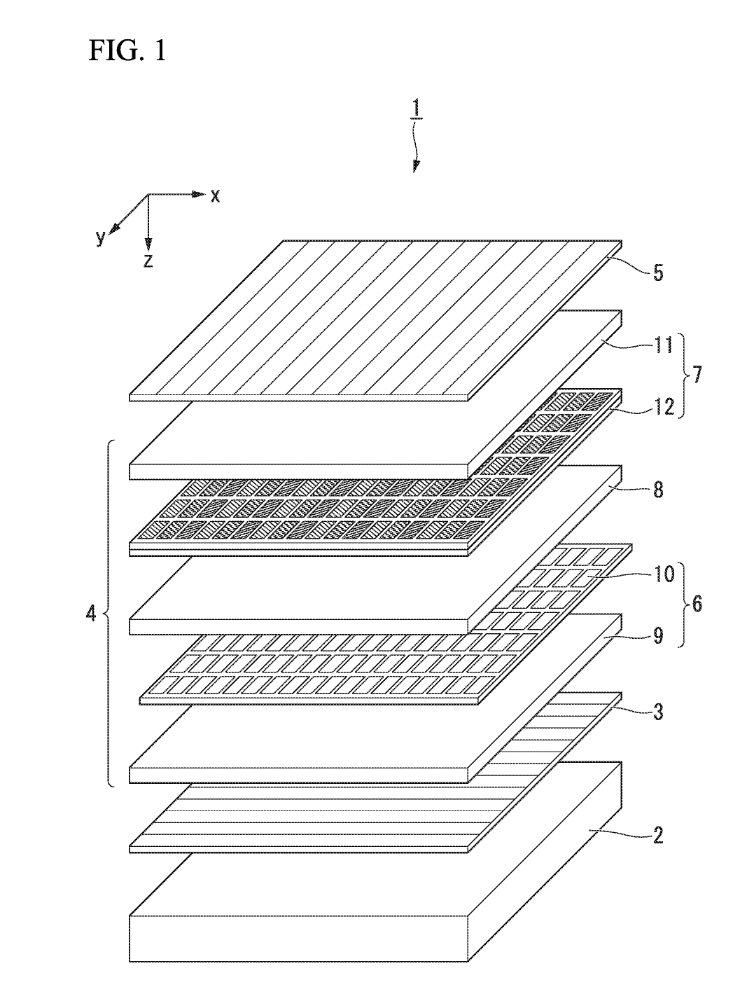

FIG. 1 is an exploded perspective view showing a schematic configuration of a display device according to a first embodiment of the present invention. Further, the display device shown in FIG. 1 is a vertical alignment (VA) type liquid crystal display device. As shown in FIG. 1, a liquid crystal display device 1 includes a backlight 2, a polarizing plate 3, a liquid crystal cell 4, and a polarizing plate 5 from a back side (a lower side of FIG. 1) seen by an observer. In this way, the liquid crystal display device 1 is a transmission type liquid crystal display device including the backlight 2, and controls transmittance of light emitted from the backlight 2 using the liquid crystal cell 4 and displays the transmittance.

Further, in the following description, a leftward/rightward direction of a screen when an observer sees the liquid crystal display device 1 is referred to as “a horizontal direction” and an upward/downward direction of the screen is referred to as “a vertical direction.” In addition, for the convenience of understanding, as shown in FIG. 1, the horizontal direction is referred to as an x-axis direction, the vertical direction is referred to as a y-axis direction, and a thickness direction of a liquid crystal display device is referred to as a z-axis direction. Further, these three directions (the x-axis direction, the y-axis direction and the z-axis direction) are perpendicular to each other.

The liquid crystal cell 4 includes a pair of substrates constituted by a TFT array substrate 6 and a color filter substrate 7, which are disposed opposite to each other. A liquid crystal layer 8 is sandwiched between the TFT array substrate 6 and the color filter substrate 7. While a positive type liquid crystal material is generally used in the liquid crystal layer 8, a negative type liquid crystal material may be used. The TFT array substrate 6 has a plurality of sub pixels 10 arranged on a substrate 9 in a matrix. A pixel is constituted by the sub pixels 10, and a display region (a screen) is constituted by a plurality of pixels. The color filter substrate 7 includes a color filter 12 on a transparent substrate 11.

Further, while not shown in FIG. 1, a plurality of source bus lines (signal lines) parallel to each other and a plurality of gate bus lines (scanning lines) parallel to each other are formed on the display region. The plurality of source bus lines and the plurality of gate bus lines are disposed to cross each other. The display region is divided into a grid shape by the plurality of source bus lines and the plurality of gate bus lines, and substantially rectangular regions that are divided become the sub pixels 10. Any one of color patterns of red (R), green (G) and blue (B) of the color filter 12 corresponds to one of the sub pixels 10. “The color pattern” in the specification is a minimum unit region of a specific color of the color filter 12 corresponding to one of the sub pixels.

The liquid crystal display device 1 of the embodiment has a resolution referred to as, for example, full HD or 4K. The liquid crystal display device 1 having a resolution of full has a pixel number of 1920×1080.

The liquid crystal display device 1 having a resolution of 4K has a pixel number of 3840×2160. Further, the resolution (the pixel number) mentioned here is merely an example, and the resolution (the pixel number) of the liquid crystal display device 1 may be an arbitrary resolution (pixel number).

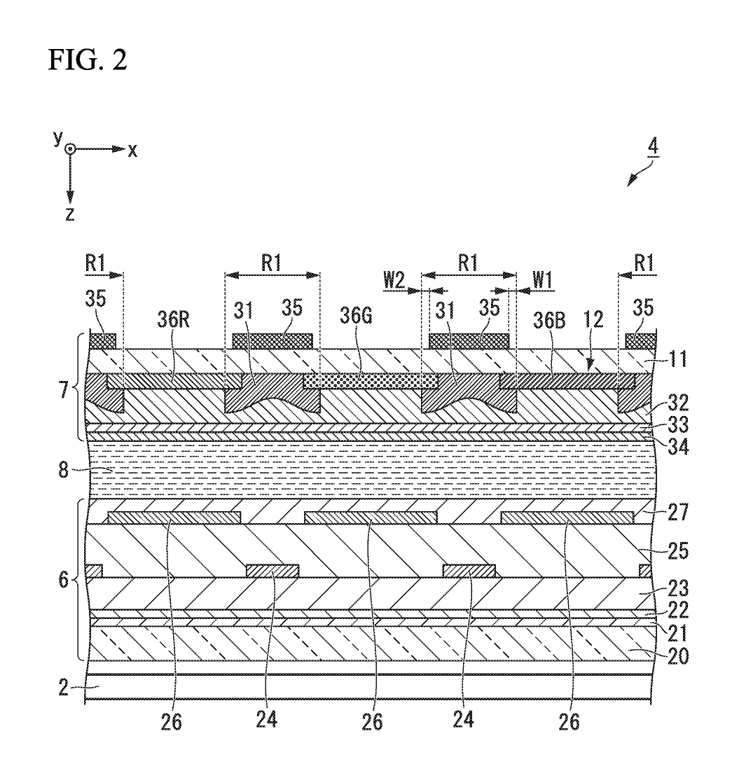

FIG. 2 is a cross-sectional view of the display device according to the first embodiment of the present invention. Further, in FIG. 2, a cross section of one pixel (three sub pixels) of the liquid crystal cell 4 in the horizontal direction is shown in an enlarged view.

As shown in FIG. 2, the liquid crystal cell 4 includes the TFT array substrate 6, the color filter substrate 7, and the liquid crystal layer 8 sandwiched between the TFT array substrate 6 and the color filter substrate 7. Further, the backlight 2 is disposed on the liquid crystal cell 4 on a +z side.

The TFT array substrate 6 may be a known VA type TFT array substrate. The TFT array substrate 6 includes a transparent substrate 20, a gate layer 21, a gate insulating film 22, an interlayer insulating film 23, a source layer 24, a flattening film 25, a pixel electrode 26, an alignment film 27, and so on. The transparent substrate 20 is, for example, a glass substrate. The gate layer 21 is a layer on which a gate bus line or the like is formed. The gate insulating film 22 is an insulating film formed to cover the gate layer 21. For example, a silicon oxide film, a silicon nitride film, a laminated film of these, or the like, is used as a material of the gate insulating film 22.

The interlayer insulating film 23 is formed on the gate insulating film 22. For example, a silicon oxide film, a silicon nitride film, a laminated film of these, or the like, is used as a material of the interlayer insulating film 23. The source layer 24 and a drain layer (not shown) are formed on the interlayer insulating film 23. The source layer 24 is a layer on which a source bus line or the like is formed. The flattening film 25 is formed on the interlayer insulating film 23 to cover the source layer 24 and the drain layer (not shown). The same material as the interlayer insulating film 23 or an organic insulating material is used as a material of the flattening film 25.

The pixel electrode 26 is formed on the flattening film 25. The pixel electrode 26 is connected to the drain layer (not shown) via a contact hole. For example, a transparent conductive material such as indium tin oxide (ITO), indium zinc oxide (IZO), or the like, is used as a material of the pixel electrode 26. The alignment film 27 is formed on the flattening film 25 to cover the pixel electrode 26, The alignment film 27 has an alignment restricting force of vertically aligning liquid crystal molecules that constitute the liquid crystal layer 8. In the embodiment, alignment processing is performed on the alignment film 27 using an optical alignment technology. That is, in the embodiment, an optical alignment film is used as the alignment film 27.

In the TFT array substrate 6 having the above-mentioned configuration, when the scanning signal is supplied through the gate bus line and the TFT is turned on, an image signal supplied through the source bus line is supplied to the pixel electrode 26. Further, a type of the TFT may be a top gate type TFT or may be a bottom gate type TFT.

The color filter substrate 7 includes the transparent substrate 11, the color filter 12, a black matrix 31 (a light shielding pattern), an overcoat layer 32, a counter electrode 33, an alignment film 34, and optical sensors 35. The transparent substrate 11 is, for example, a glass substrate. The color filter 12 has a plurality of red patterns 36R (first color patterns), a plurality of green patterns 36G (second color patterns), and a plurality of blue patterns 36B (third color patterns), which are arranged in the horizontal direction and the vertical direction of the screen.

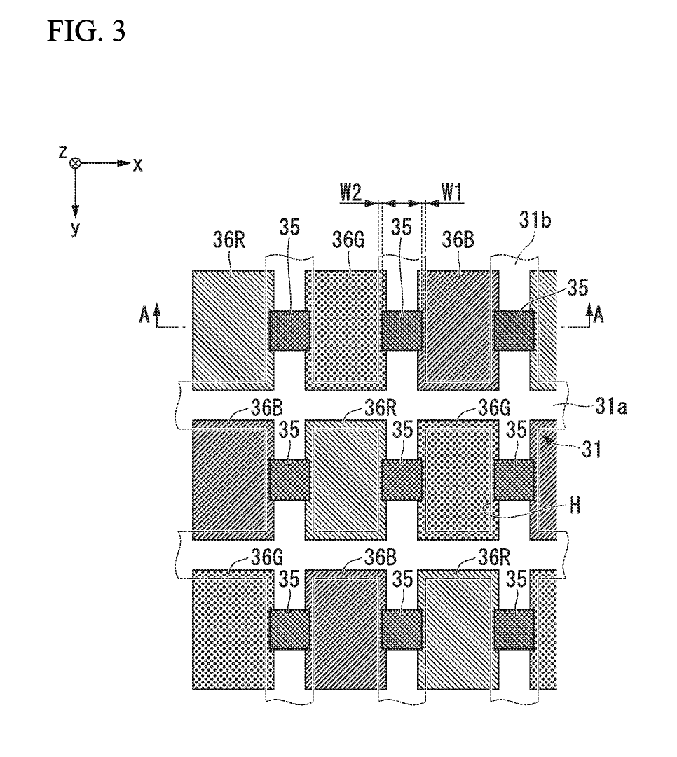

FIG. 3 is a plan view of the display device according to the first embodiment of the present invention. In FIG. 3, sub pixels of three rows and three columns are shown in an enlarged view. Further, FIG. 2 is a cross-sectional view taken along line A-A of FIG. 3. In the uppermost row of FIG. 3, the color pattern is arranged in sequence of the red patterns 36R, the green patterns 36G, the blue patterns 36B . . . from a left end to a right end. In the second row of FIG. 3 from above, the color pattern is arranged in sequence of the blue patterns 36B, the red patterns 36R, the green patterns 36G . . . from the left end to the right end. In the lowermost row of FIG. 3, the color pattern is arranged in sequence of the green patterns 36G, the blue patterns 36B, the red patterns 36R . . . from the left end to the right end. In regions outside the range shown in FIG. 3, the pattern of FIG. 3 is repeated.

The plurality of color patterns having the same color that constitute the color filter 12 are arranged to adjoin in an inclined direction crossing the horizontal direction and the vertical direction. Specifically, the red pattern 36R is arranged diagonally to a right lower side of the red pattern 36R of a left end of an upper stage in FIG. 3, and the red pattern 36R is arranged diagonally to a right lower side of the second red pattern 36R from a left side of an intermediate stage. The green patterns 36G and the blue patterns 36B are also the same as the red patterns 36R. Such an arrangement is referred to as a so-called mosaic arrangement.

The black matrix 31 has a grid shape in which a plurality of the horizontal linear sections 31a (first linear sections) extending in the horizontal direction (a first direction) and a plurality of vertical linear sections 31b (second linear sections) extending in the vertical direction (a second direction) cross each other at one surface side (a +z side) of the transparent substrate 11. The black matrix 31 is constituted by a light blocking material such as a black resin, a metal or the like, for example, chromium (Cr), or the like.

The black matrix 31 has a plurality of rectangular opening sections H disposed in a matrix, Areas of the opening sections H are set to be smaller than areas of the red patterns 36R, the green patterns 36G and the blue patterns 36B of the color filter 12. That is, when the color filter substrate 7 is seen from the liquid crystal layer 8 side, end portions (four sides) of the red patterns 36R, the green patterns 36G and the blue patterns 36B are covered by the black matrix 31. For this reason, the opening sections H become substantial display regions in the sub pixels 10.

The overcoat layer 32 is formed to cover surfaces of the color filter 12 and the black matrix 31 and attenuate a step difference between the color filter 12 and the black matrix 31. The counter electrode 33 is formed on the overcoat layer 32. Like the pixel electrode 26, for example, a transparent conductive material such as ITO, IZO, or the like, is used as a material of the counter electrode 33. The alignment film 34 is formed on the entire surface of the pixel electrode 26. Like the alignment film 27, the alignment film 34 has an alignment restricting force of vertically aligning liquid crystal molecules that constitute the liquid crystal layer 8. In the embodiment, alignment processing is performed on the alignment film 34 using an optical alignment technology. That is, in the embodiment, like the alignment film 27, an optical alignment film is used as the alignment film 34.

The optical sensors 35 are optical sensors such as photo diodes or the like having, for example, pn coupling.

As shown in FIGS. 2 and 3, the optical sensors 35 are formed on the other surface (a surface of a −z side) of the transparent substrate 11 to overlap the vertical linear sections 31b of the black matrix 31 when seen from a direction perpendicular to the transparent substrate 11, That is, the optical sensors 35 are formed in a shielding region R1 in which light emitted from the backlight 2 is shielded by the black matrix 31. In this way, the optical sensors 35 are formed in the shielding region R1 so as not to be affected by the light emitted from the backlight 2. The optical sensors 35 are formed such that a light receiving surface is directed to the −z side.

As shown in FIG. 3; the optical sensors 35 are formed to correspond to the red patterns 36R, the green patterns 36G and the blue patterns 36B. That is, the optical sensors 35 are formed to correspond to the sub pixels 10. Shapes of the optical sensors 35 when seen in a plan view are square shapes, and lengths of one sides of the optical sensors 35 are set to a width of the vertical linear section 31b or less. For this reason, the optical sensors 35 may have dot shapes when seen from a direction perpendicular to the transparent substrate 11, and may be arranged to be dotted in the horizontal direction and the vertical direction of the screen.

Here, the optical sensors 35 are disposed inside retreat regions W1 and W2 set at end portions of the black matrix 31, The retreat regions W1 and W2 are regions in which light wrapping around the shielding region R1 of the light emitted from the backlight 2 and transmitted by the opening sections H of the black matrix 31 is prevented from being received by the optical sensors 35. Widths of the retreat regions W1 and W2 are set in consideration of a wraparound amount of light and a dimension of the optical sensors 35 (sensitivity of the optical sensors 35). The width of the retreat region W1 may be equal to or different from the width of the retreat region W2.

Further, in FIG. 2, while shown in a simplified form, a transparent protective film configured to protect the optical sensors 35 may be formed on the other surface (a surface of the −z side) of the transparent substrate 11 to cover the optical sensors 35. In addition, while not shown in FIGS. 2 and 3, a signal line configured to output a detection signal of the optical sensors 35 to the outside is formed in the shielding region R1 (for example, the shielding region R1 in the horizontal linear section 31a of the black matrix 31).

As described above, in the embodiment, the optical sensors 35 corresponding to each of the sub pixels 10 are installed in the shielding region R1 of the color fitter substrate 7 (a region in which light emitted from the backlight 2 is shielded by the black matrix 31). Since tight and shade (including light and shade due to environmental light) of the screen surface of the liquid crystal display device 1 can be accurately detected by the optical sensors 35, an accurate touch panel can be realized. Accordingly, it is possible to detect not only operations by a user's finger but also minute operations using a stylus pen or the like.

In addition, in the embodiment, as processing with respect to a detection signal of the optical sensors 35 is changed, the optical sensors 35 can be used as a touch panel, a fingerprint sensor, or a proximity sensor. When the optical sensors 35 are used as the touch panel, processing of detecting a dark region (dot) having a small area in a light region having a large area is performed. This is because, while a quantity of light entering the optical sensors 35 decreases in a portion touched by a finger, such a decrease in light quantity does not occur in a portion that is not touched by a finger.

When the optical sensors 35 are used as the fingerprint sensor, processing of detecting a gradation is performed on the dark region having the small area. This is because reflected light of the light emitted from the backlight 2 (reflected light having a gradation according to a shape of a fingerprint reflected by a finger tip) in the portion touched by the finger is detected by the optical sensors 35. When the optical sensors 35 are used as a proximity sensor, processing of detecting a dark region having an area of a certain extent or more is performed in the light region having a large area. This is the same theory as the case in which the optical sensors 35 are used as the touch panel. In this way, in the embodiment, the optical sensors 35 can be used properly as a touch panel, a fingerprint sensor, or a proximity sensor depending on the application.

### Second Embodiment

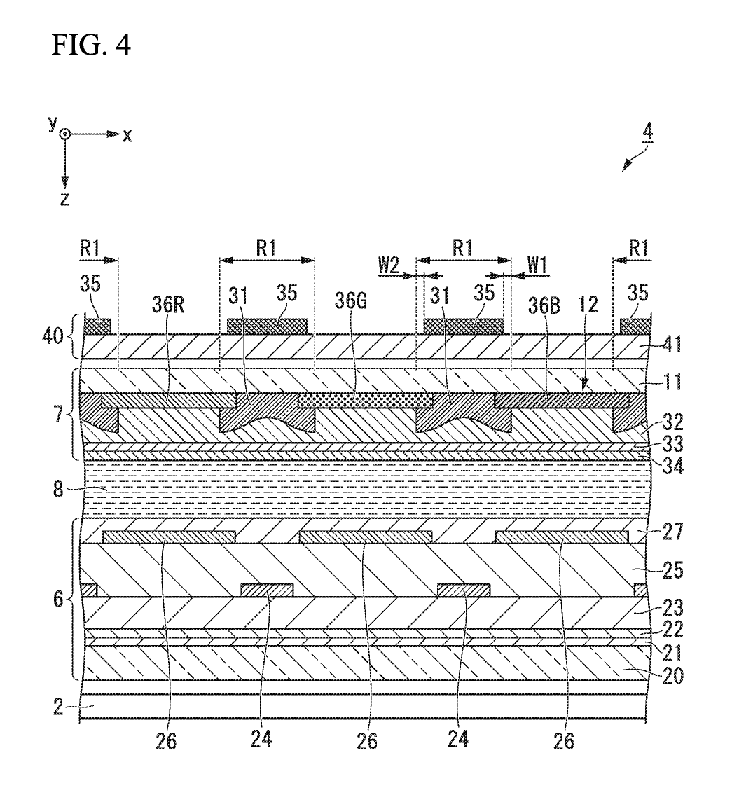

FIG. 4 is a cross-sectional view of a display device according to a second embodiment of the present invention. Further, like the cross-sectional view shown in FIG. 2, the cross-sectional view shown in FIG. 4 is obtained by enlarging a cross section of a single pixel (three sub pixels) of the liquid crystal cell 4 in the horizontal direction. In addition, in FIG. 4, the same components as in FIG. 2 are designated by the same reference numerals.

The liquid crystal display device of the embodiment includes the backlight 2, the polarizing plate 3, the liquid crystal cell 4, and the polarizing plate 5, Which are shown in FIG. 1, and basic configurations thereof are the same as in the first embodiment. However, the liquid crystal display device of the embodiment is distinguished from the first embodiment in that the configuration of the color filter substrate 7 is slightly different therefrom and a sensor substrate 40 is added, Specifically, the liquid crystal display device of the embodiment has a configuration in which the optical sensors 35 of the color filter substrate 7 of the first embodiment are omitted and the sensor substrate 40 on which the optical sensors 35 are installed is newly installed.

The sensor substrate 40 includes a substrate 41 and the optical sensors 35 formed on the substrate 41. The sensor substrate 40 is disposed such that one surface (a surface of a +z side) in which the optical sensors 35 are not formed is directed toward the color filter substrate 7 and overlaps the color filter substrate 7.

The substrate 41 is, for example, a polarizing plate, or a cover glass serving as a glass substrate configured to protect the color filter substrate 7.

Like the optical sensors 35 shown in FIGS. 2 and 3, the optical sensors 35 are optical sensors such as photo diodes or the like having, for example, pn coupling. The optical sensors 35 is formed on the other surface (the surface of the −z side) of the substrate 41 to overlap the black matrix 31 in a direction perpendicular to the substrate 41 when the sensor substrate 40 overlaps the color filter substrate 7. That is, the optical sensors 35 are formed to be disposed in the shielding region R1 in which light emitted from the backlight 2 is shielded by the black matrix 31 when the sensor substrate 40 overlaps the color filter substrate 7. Further, the optical sensors 35 are formed such that a light receiving surface is directed toward the −z side.

Like the first embodiment, the optical sensors 35 are installed to correspond to the red patterns 36R, the green patterns 36G, and the blue patterns 36B. That is, the optical sensors 35 are installed to correspond to the sub pixels 10 in this embodiment as well (see FIG. 3).

In addition, in order to prevent bad influence of wraparound of light, the optical sensors 35 is disposed inside the retreat regions W1 and W2 set at the end portions of the black matrix 31. Further, a transparent protective film configured to protect the optical sensors 35 may be formed on the other surface (the surface of the −z side) of the substrate 41 to cover the optical sensor 35 in this embodiment as well.

As described above, in the embodiment, when the optical sensors 35 are installed on the sensor substrate 40 overlapping the color filter substrate 7 and the sensor substrate 40 overlaps the color filter substrate 7, the optical sensors 35 of the sensor substrate 40 are disposed in the shielding region R1 of the color filter substrate 7, For this reason, when an accurate touch panel can be realized as in the first embodiment, it is possible to detect not only operations by a user's finger but also minute operations using a stylus pen or the like. In addition, because processing with respect to a detection signal of the optical sensors 35 is changed, the optical sensor 35 may be used as a touch panel, a fingerprint sensor, or a proximity sensor in this embodiment as well.

In addition, in the embodiment, since the optical sensors 35 are formed on the sensor substrate 40 separated from the color filter substrate 7, a manufacturing process of the color filter substrate 7 can be simplified. That is, in the first embodiment, since there is a need to form the color filter 12 on one surface of the transparent substrate 11 of the color filter substrate 7 and form the optical sensors 35 on the other surface, the manufacturing process of the color filter substrate 7 is complicated. On the other hand, in the embodiment, since there is no need to form the optical sensors 35 on the other surface of the transparent substrate 11 of the color filter substrate 7, a manufacturing process of the color filter substrate 7 can be simplified.

### Third Embodiment

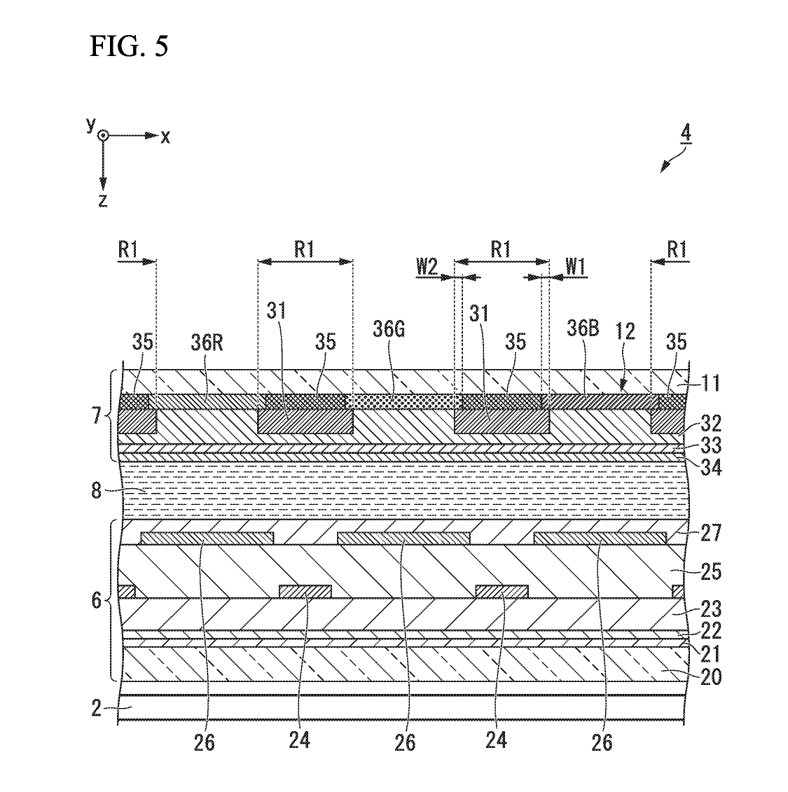

FIG. 5 is a cross-sectional view of a display device according to a third embodiment of the present invention. Further, like the cross-sectional view shown in FIGS. 2 and 4, the cross-sectional view shown in FIG. 5 is shown by enlarging a cross section of a single pixel (three sub pixels) of the liquid crystal cell 4 in the horizontal direction. In addition, in FIG. 5, the same components as in FIGS. 2 and 4 are designated by the same reference numerals.

The liquid crystal display device of the embodiment includes the backlight 2, the polarizing plate 3, the liquid crystal cell 4, and the polarizing plate 5, which are shown in FIG. 1, and basic configurations thereof are the same as in the first embodiment. However, the liquid crystal display device of the embodiment is distinguished from the first embodiment in that a configuration of the color filter substrate 7 is slightly different. Specifically, the liquid crystal display device of the embodiment has a configuration in which the color filter substrate 7 of the first embodiment is replaced with a substrate on which the color filter 12 and the optical sensors 35 are formed on one surface (the surface of the +z side) of the transparent substrate 11.

As shown in FIG. 5, the optical sensors 35 are formed on one surface of the transparent substrate 11 and formed between the red patterns 36R, the green patterns 360 and the blue patterns 36B of the color filter 12. In addition, the black matrix 31 is formed at one surface side of the transparent substrate 11 to cover the optical sensors 35. That is, the optical sensors 35 are formed between the transparent substrate 11 and the black matrix 31 at one surface side of the transparent substrate 11. Accordingly, the optical sensors 35 are formed to overlap the black matrix 31 when seen in a direction perpendicular to the transparent substrate 11. That is, the optical sensors 35 are formed in the shielding region R1 in which light emitted from the backlight 2 is shielded by the black matrix 31.

Further, the optical sensors 35 are formed such that a light receiving surface is directed toward the −z side.

Like the first and second embodiments, the optical sensors 35 are installed to correspond to the red patterns 36R, the green patterns 36G and the blue patterns 36B. That is, the optical sensors 35 are installed to correspond to the sub pixels 10 in this embodiment as well (see FIG. 3). In addition, in order to prevent bad influence of wraparound of light, the optical sensors 35 are disposed inside the retreat regions W1 and W2 set at the end portions of the black matrix 31.

The color filter substrate 7 of the above-mentioned configuration is manufactured via a first process of forming the optical sensors 35 on one surface of the transparent substrate 11, a second process of forming the color filter 12 on the one surface of the transparent substrate 11, a third process of forming the black matrix 31 that covers the optical sensors 35, and other processes. Further, the other processes are processes of forming the overcoat layer 32, the counter electrode 33, the alignment film 34, the optical sensors 35, and so on.

As described above, in the embodiment, like the first embodiment, the optical sensors 35 corresponding to the sub pixels 10 are installed in the shielding region R1 of the color filter substrate 7 (a region in which light emitted from the backlight 2 is shielded by the black matrix 31). For this reason, like the first embodiment, an accurate touch panel can be realized, and thus it is possible to detect not only operations by a user's finger but also minute operations using a stylus pen or the like. In addition, as processing with respect to a detection signal of the optical sensors 35 is changed, the optical sensors 35 may be used as a touch panel, a fingerprint sensor, or a proximity sensor in this embodiment as well.

In addition, in the embodiment, since the color filter 12 and the optical sensors 35 are formed on one surface of the transparent substrate 11, a manufacturing process of the color filter substrate 7 can be simplified. That is, when the color filter 12 is formed on one surface of the transparent substrate 11 of the color filter substrate 7 and the optical sensors 35 are formed on the other surface like the first embodiment, after processing on one surface is performed, since there is a need to protect the one surface and perform processing on the other surface, the manufacturing process is complicated. On the other hand, in the embodiment, since processing on only one surface may be performed and there is no need to perform processing on both surfaces, the manufacturing process can be simplified.

### Variants of First to Third Embodiments

### <First Variant>

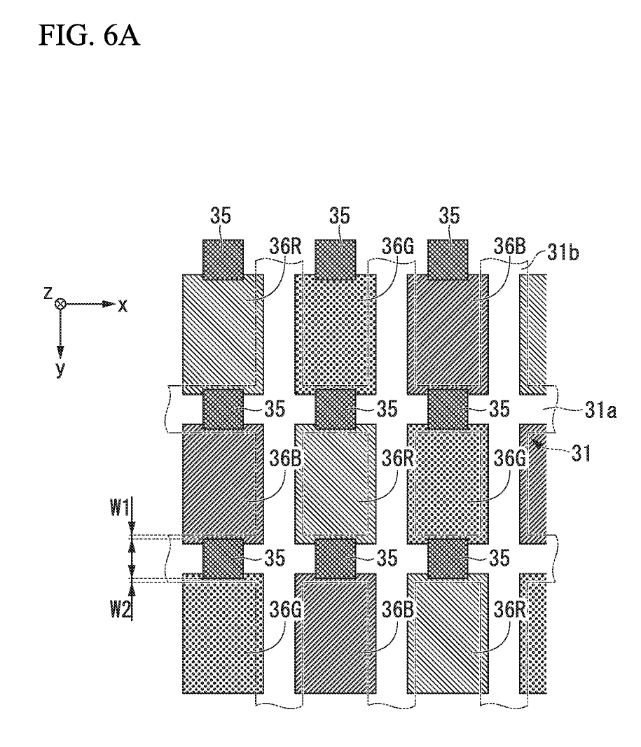

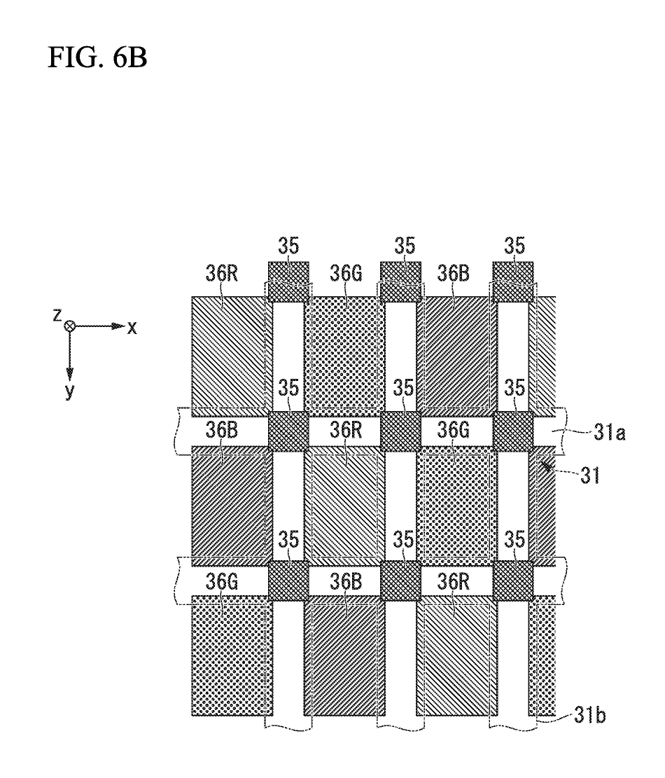

FIGS. 6A and 6B are first and second plan views showing a first variant of the display device according to the first to third embodiments of the present invention. Further, the plan views shown in FIGS. 6A and 6B are shown by enlarging sub pixels of three rows and three columns like the plan view shown in FIG. 3. The variant is obtained by changing disposition of the optical sensors 35 formed on the color filter substrate 7 of the first and third embodiments or the sensor substrate 40 of the second embodiment.

In the above-mentioned first to third embodiments, as shown in FIG. 3, the optical sensors 35 overlap the vertical linear sections 31b of the black matrix 31 when seen in a direction perpendicular to the transparent substrate 11 or the substrate 41, and are formed on the transparent substrate 11 or the substrate 41 to correspond to the red patterns 36R, the green patterns 36G and the blue patterns 36B. On the other hand, while the variant is the same as that of FIG. 3 in that the optical sensors 35 are formed on the transparent substrate 11 or the substrate 41 to correspond to the red patterns 36R, the green patterns 360 and the blue patterns 36B, specific disposition of the optical sensors 35 is different therefrom.

The optical sensors 35 shown in FIG. 6A are disposed to overlap the horizontal linear sections 31a of the black matrix 31 when seen in a direction perpendicular to the transparent substrate 11 or the substrate 41. In addition, the optical sensors 35 shown in FIG. 6B are disposed to overlap intersections at which the horizontal linear sections 31a and the vertical linear sections 31b of the black matrix 31 cross each other when seen from a direction perpendicular to the transparent substrate 11 or the substrate 41. Further, in order to prevent bad influence of wraparound of light, all of the optical sensors 35 shown in FIGS. 6A and 6B are disposed inside the retreat regions W1 and W2 set at the end portions of the black matrix 31.

In this way, the optical sensors 35 can be formed to overlap the horizontal linear sections 31a of the black matrix 31 and the vertical linear sections 31b of the black matrix 31, and all of intersections at which the horizontal linear sections 31a and the vertical linear sections 31b of the black matrix 31 cross each other, when seen in a direction perpendicular to the transparent substrate 11 or the substrate 41. For this reason, disposition of the optical sensors 35 can be changed according to the configuration of the liquid crystal display device, and a degree of design freedom can be increased.

### <Second Variant>

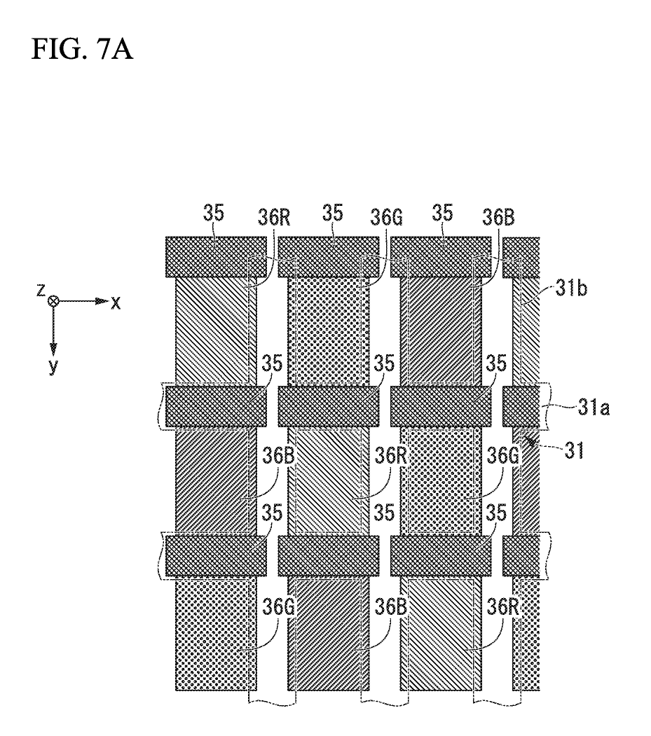

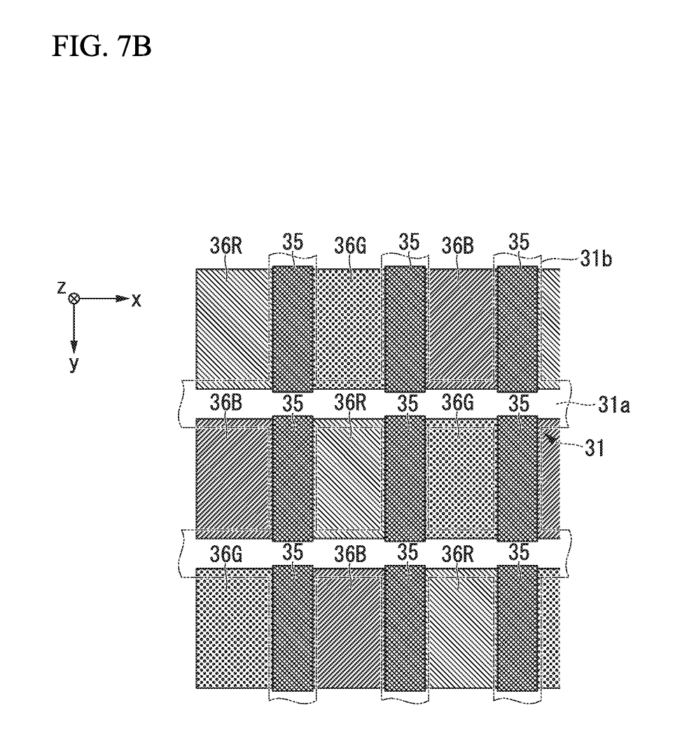

FIGS. 7A and 7B are first and second plan views showing a second variant of the display device according to the first to third embodiments of the present invention. Further, the plan views shown in FIGS. 7A and 7B are shown by enlarging sub pixels of three rows and three columns like the plan views shown in FIGS. 3, 6A and 6B, The variant is obtained by changing shapes of the optical sensors 35 formed on the color filter substrate 7 of the first and third embodiments or the sensor substrate 40 of the second embodiment.

In the above-mentioned first to third embodiments, as shown in FIG. 3, shapes of the optical sensors 35 when seen in a plan view were square shapes (i.e., dot shapes when seen from a direction perpendicular to the transparent substrate 11 or the substrate 41). On the other hand, shapes of the optical sensors 35 in the variant when seen in a plan view are rectangular shapes extending in the horizontal direction or the vertical direction (i.e., linear shapes when seen from a direction perpendicular to the transparent substrate 11 or the substrate 41).

The optical sensors 35 shown in FIG. 7A have linear shapes extending in the horizontal direction when seen from a direction perpendicular to the transparent substrate 11 or the substrate 41, and are disposed to overlap the horizontal linear section 31a of the black matrix 31. In addition, the optical sensors 35 shown in FIG. 7B have linear shapes extending in the vertical direction when seen from a direction perpendicular to the transparent substrate 11, and are disposed to overlap the vertical linear sections 31b of the black matrix 31. A length of the optical sensors 35 shown in FIGS. 7A and 79 may be set arbitrarily as long as the optical sensors 35 do not overlap each other when seen in a plan view. Further, all of the optical sensors 35 shown in FIGS. 6A and 69 are formed to correspond to the red patterns 36R, the green patterns 36G and the blue patterns 36B, and disposed inside the retreat regions W1 and W2 (see FIG. 3 or 6A) set at, the end portions of the black matrix 31 in order to prevent bad influence of wraparound of light.

In this way, the optical sensors 35 may have any of linear shapes extending in the horizontal direction and linear shapes extending in the vertical direction when seen in a direction perpendicular to the transparent substrate 11 or the substrate 41. In addition, a length of the optical sensors 35 may be set arbitrarily as long as the optical sensors 35 do not overlap each other when seen in a plan view. For this reason, a shape and a length of the optical sensors 35 can be changed according to the configuration of the liquid crystal display device, and a degree of design freedom can be increased.

### <Third Variant>

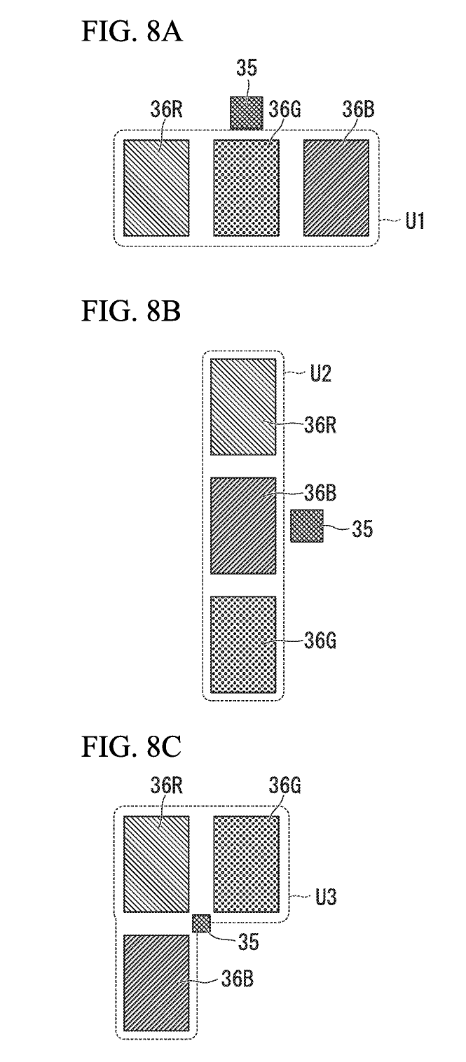

FIGS. 8A to 8C are first to third plan views showing a third variant of the display device according to the first to third embodiments of the present invention. Further, the plan views shown in FIGS. 8A to 8C are shown by enlarging three sub pixels. The variant is obtained by changing correspondence of the optical sensors 35 formed on the color filter substrate 7 of the first and third embodiments or the sensor substrate 40 of the second embodiment.

In the above-mentioned first to third embodiments, the optical sensors 35 are formed to correspond to the red patterns 36R, the green patterns 36G and the blue patterns 36B (correspond to the sub pixels 10). On the other hand, in the variant, the optical sensors 35 are installed to correspond to unit divisions each including a red pattern 36R, a green pattern 36G and a blue pattern 36B (to each of unit divisions).

The optical sensor 35 shown in FIG. 8A is installed on a unit division U1 including a red pattern 36R, a green pattern 36G and a blue pattern 36B, which are continuously arranged in the horizontal direction. The optical sensor 35 shown in FIG. 8B is installed on a unit division U2 including a red pattern 36R, a green pattern 36G, and a blue pattern 36B, which are continuously arranged in the vertical direction. Further, the length of the optical sensor 35 shown in FIG. 8A can be appropriately varied in the horizontal direction, and the length of the optical sensor 35 shown in FIG. 8B can be appropriately varied in the vertical direction.

The optical sensor 35 shown in FIG. 8C is installed on a unit division U3 including a red pattern 36R, a green pattern 36G, and a blue pattern 36B, which are disposed in adjacent two stages. Specifically, the optical sensor 35 is installed on the unit division U3 including the red pattern 36R and the green pattern 36G of an upper stage, and the blue pattern 36B of a lower stage disposed below the red pattern 36R of the upper stage shown in FIG. 8C.

In this way, the optical sensors 35 may be installed to correspond to each of the sub pixels 10 or may be installed to correspond to each unit division including a plurality of sub pixels 10. In addition, a length of the optical sensors 35 is set arbitrarily as long as the optical sensors 35 do not overlap each other when seen in a plan view. For this reason, the number of the optical sensors 35 can be changed according to required definition, cost, sensitivity of the optical sensors 35, and so on.

While the color filter substrate, the sensor substrate and the display device according to the embodiments of the present invention have been described above, the present invention is not limited to the above-mentioned embodiments and may be freely changed without departing from the spirit of the present invention. For example, while an example in which the color filter substrate 7 or the sensor substrate 40 is applied to the vertical alignment (VA) type liquid crystal display device has been described in the above-mentioned embodiments, it may also be applied to a liquid crystal display device other than the vertical alignment (VA) type. For example, the color filter substrate 7 or the sensor substrate 40 may be applied to a transverse electric field type liquid crystal display device. The transverse electric field type liquid crystal display device is a liquid crystal display device including a common electrode and a pixel electrode on one of a pair of substrates that sandwich a liquid crystal layer, and in which a liquid crystal is driven by an electric field applied between the common electrode and the pixel electrode.

In addition, while an example of the color filter substrate having a color pattern of three colors of red, green and blue has been exemplified in the above-mentioned embodiments, the present invention may be applied to a color filter substrate having a color pattern of four colors or more. In addition, the shapes, number, disposition, constituent materials, manufacturing method, and so on, of the color filter substrate and the liquid crystal display device are not limited to the embodiments and may be appropriately modified. In addition, the color filter substrate of the present invention may be applied to a display device including a color filter other than a liquid crystal display device, for example, an organic electroluminescence display device or the like.

### INDUSTRIAL APPLICABILITY

Some aspects of the present invention may be used in the color filter substrate or the like capable of detecting minute operations using a pen or the like and realizing a plurality of kinds of sensors using one sensor.

### DESCRIPTION OF THE REFERENCE SYMBOLS

1 Liquid crystal display device
7 Color titter substrate
11 Transparent substrate
12 Color filter
31 Black matrix
31a Horizontal linear section
31b Vertical linear section
35 Optical sensor
36R Red pattern
36G Green pattern
36B Blue pattern
40 Sensor substrate
41 Substrate
U1, U2, U3 Unit division
W1, W2 Retreat region

1. A color filter substrate comprising:
a transparent substrate;
a light shielding pattern formed at one surface side of the transparent substrate in a grid shape;
color filters installed on regions of the transparent substrate divided by the light shielding pattern; and
optical sensors formed on one surface or the other surface of the transparent substrate to overlap the light shielding pattern seen from a direction perpendicular to the transparent substrate.

2. The color filter substrate according to claim 1, wherein the optical sensors are disposed inside a retreat region set at an end portion of the light shielding pattern.

3. The color filter substrate according to claim 1, wherein the optical sensors are formed between the transparent substrate and the light shielding pattern at one surface side of the transparent substrate.

4. The color filter substrate according to claim 1, wherein the light shielding pattern is formed to extend in a first direction and a second direction that are perpendicular to each other at one surface side of the transparent substrate, and
the optical sensors are formed to overlap a first linear section extending in the first direction of the light shielding pattern, a second linear section extending in the second direction of the light shielding pattern, or an intersection at which the first linear section and the second linear section cross each other.

5. The color filter substrate according to claim 4, wherein the optical sensors have dot shapes when seen in a direction perpendicular to the transparent substrate or linear shapes extending in the first direction or the second direction.

6. The color filter substrate according to claim 5, wherein the color filter has a first color pattern, a second color pattern and a third color pattern, which are arranged in the first direction and the second direction, and
the optical sensors are installed to correspond to the first color pattern, the second color pattern and the third color pattern.

7. The color filter substrate according to claim 5, wherein the color filter has first color patterns, second color patterns and third color patterns, which are arranged in the first direction and the second direction, and
the optical sensors are installed in unit divisions each including a first color pattern, a second color patter a third color pattern.

8. A sensor substrate comprising:
a substrate; and
optical sensors formed on one surface of the substrate to overlap a grid-shaped light shielding pattern from a direction perpendicular to the substrate when the substrate overlaps a color filter substrate on which the light shielding pattern is formed.

9. The sensor substrate according to claim 8, wherein the optical sensors are formed to be disposed inside a retreat region set at an end portion of the light shielding pattern when the substrate overlaps the color titter substrate.

10. The sensor substrate according to claim 8, wherein the substrate is a polarizing plate or a glass substrate.

11. A display device comprising the color filter substrate according to claim 1.

12. A display device comprising:
a color filter substrate comprising a transparent substrate, a light shielding pattern formed at one surface side of the transparent substrate in a grid shape, and color filters installed on regions of the transparent substrate divided by the light shielding pattern; and
the sensor substrate according to claim 8.
